(19) United States
(12) Patent Application Publication
(10) Pub. No.: US 2025/0047125 A1
(43) Pub. Date: Feb. 6, 2025

(54) BATTERY UNIT AND POWER SUPPLY SYSTEM

(71) Applicant: Murata Manufacturing Co., Ltd., Nagaokakyo-shi (JP)

(72) Inventor: Kouta FURUHASHI, Nagaokakyo-shi (JP)

(73) Assignee: Murata Manufacturing Co., Ltd., Nagaokakyo-shi (JP)

(21) Appl. No.: 18/921,126

(22) Filed: Oct. 21, 2024

Related U.S. Application Data
(63) Continuation of application No. PCT/JP2023/005733, filed on Feb. 17, 2023.

(30) Foreign Application Priority Data
Apr. 28, 2022 (JP) 2022-074633

(51) Int. Cl. H02J 7/04; H02J 7/00

(52) U.S. Cl. CPC H02J 7/04; H02J 7/0013; H02J 7/00304; H02J 7/0047; H02J 7/0063; H02J 2310/16

(57) ABSTRACT

A battery unit includes a first coupling terminal, a second coupling terminal configured to be coupled to a storage battery, a power converter coupled between the first coupling terminal and the second coupling terminal, and a controller configured to control the power converter and to measure a terminal voltage of the first coupling terminal and a current flowing from the power converter to the second coupling terminal. In a state that the current is flowing from the power converter to the second coupling terminal, the controller compares the terminal voltage and a first threshold value, and assuming the terminal voltage crosses the first threshold value, the controller controls the power converter to decrease the current flowing from the power converter to the second coupling terminal until the terminal voltage crosses the first threshold value again.

### CROSS-REFERENCE TO RELATED APPLICATIONS

This is a continuation application of PCT/JP2023/005733, filed on Feb. 17, 2023, designating the United States of America, which is based on and claims priority to Japanese Patent Application No. JP 2022-074633 filed on Apr. 28, 2022. The entire contents of the above-identified applications, including the specifications, drawings and claims, are incorporated herein by reference in their entirety.

### TECHNICAL FIELD

The present disclosure relates to a battery unit and a power supply system.

### BACKGROUND ART

Patent Document 1 discloses a power supply system in which power supply units and a load are coupled in parallel. The power supply system of Patent Document 1 operates in any of a normal mode, a backup mode, and an assist mode, thereby enabling appropriate control of an amount of power shared by batteries at a time of peak load without providing a complicated common controller or a large-scale mutual communication infrastructure.

### CITATION LIST

### Patent Document

Patent Document 1: International Publication No. 2015/015570

### SUMMARY OF DISCLOSURE

### Technical Problem

There has been a problem that a battery unit used for a power supply system of a known technology cannot sense a heavy load assuming the load is changed to be heavy while the battery unit is being charged from a power supply unit, and causes overcurrent in the power supply unit by continuing charging. Although the heavy load may be sensed by adding a dedicated device such as a signal line for notifying the heavy load to the battery unit, the configuration of the battery unit becomes complicated. In view of the above, an object of the present disclosure is to provide a battery unit that may suppress occurrence of overcurrent in a power supply unit with a simple configuration, even assuming a load variation occurs during charging to the battery unit.

### Solution to Problem

A battery unit of an aspect of the present disclosure includes a first coupling terminal, a second coupling terminal configured to be coupled to a storage battery, a power converter coupled between the first coupling terminal and the second coupling terminal, and a controller configured to control the power converter, to measure a terminal voltage value of the first coupling terminal and a current flowing from the power converter to the second coupling terminal, and to compare the terminal voltage value and a first threshold value being set. The first threshold value includes a first value and a second value being set within a voltage range including the first threshold value, and in a state that a current is flowing from the power converter to the second coupling terminal, assuming the terminal voltage value varies in a predetermined direction and crosses the first value, the controller controls the power converter to decrease the current flowing from the power converter to the second coupling terminal until the terminal voltage value varies in a direction opposite to the predetermined direction and crosses the second value.

A battery unit of an aspect of the present disclosure includes a storage battery, a first coupling terminal, a second coupling terminal configured to be coupled to the storage battery, a power converter coupled between the first coupling terminal and the second coupling terminal, and a controller configured to control the power converter, to measure a terminal voltage value of the first coupling terminal and a charging current flowing from the power converter to the second coupling terminal, and to compare the terminal voltage value and a first threshold value being set. The first threshold value includes a first value and a second value being set within a voltage range including the first threshold value, and in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

A power supply system of an aspect of the present disclosure includes a plurality of battery units coupled to a device in parallel. Each of the plurality of battery units includes a storage battery, a first coupling terminal configured to be coupled to the device, a second coupling terminal configured to be coupled to the storage battery, a power converter coupled between the first coupling terminal and the second coupling terminal, and a controller configured to control the power converter, to measure a terminal voltage value of the first coupling terminal and a charging current flowing from the power converter to the second coupling terminal, and to compare the terminal voltage value and a first threshold value being set. The first threshold value includes a first value and a second value being set within a voltage range including the first threshold value, and the controller includes a memory configured to memorize the first threshold value, in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

A power supply system of an aspect of the present disclosure includes a power supply unit including an output terminal configured to be coupled to a device, and configured to convert input power into DC power and to output the DC power to the output terminal and a battery unit coupled to the device in parallel with the power supply unit. The battery unit includes a storage battery, a first coupling terminal configured to be coupled to the output terminal, a second coupling terminal configured to be coupled to the storage battery, a power converter coupled between the first coupling terminal and the second coupling terminal, and a controller configured to control the power converter, to measure a terminal voltage value of the first coupling terminal and a charging current flowing from the power converter to the second coupling terminal, and to compare the terminal voltage value and a first threshold value being set. The first threshold value includes a first value and a second value being set within a voltage range including the first threshold value, and in a state that the charging current is flowing, assuming the terminal voltage value of the first coupling terminal varies in a predetermined direction and crosses the first value, the controller controls the power converter to decrease the charging current until the terminal voltage value varies in a direction opposite to the predetermined direction and crosses the second value.

### Advantageous Effects of Disclosure

A battery unit capable of suppressing overcurrent due to a load variation, and a power supply system using the battery unit may be provided.

### BRIEF DESCRIPTION OF DRAWINGS

FIG. 1 is a block diagram illustrating a power supply system of a first embodiment.

FIG. 2 is a circuit diagram illustrating a configuration example of a battery unit of the power supply system in FIG. 1.

FIG. 3 is a flowchart illustrating an operation of the battery unit in FIG. 2.

FIG. 4 is a waveform diagram illustrating an operation of the power supply system in FIG. 1.

FIG. 5 is a waveform diagram illustrating an operation of a power supply system of a second embodiment.

FIG. 6 is a circuit diagram illustrating a battery unit of a modification.

FIG. 7 is a block diagram illustrating a configuration example for operation confirmation of the battery unit.

### DESCRIPTION OF EMBODIMENTS

Hereinafter, some embodiments of a battery unit and a power supply system of the present disclosure will be described with reference to the accompanying drawings.

The accompanying drawings only exemplify the embodiments of the present disclosure and should not be considered to limit the present disclosure. The terms “first”, “second”, “third”, and the like in the present disclosure are used to merely distinguish objects, but not to rank the objects.

The following detailed description includes units, systems, and methods that embody exemplary embodiments of the present disclosure. The detailed description is merely illustrative in nature and is not intended to limit the embodiments or the application and use of such embodiments of the present disclosure.

### First Embodiment

Hereinafter, a first embodiment will be described.

### (Power Supply System)

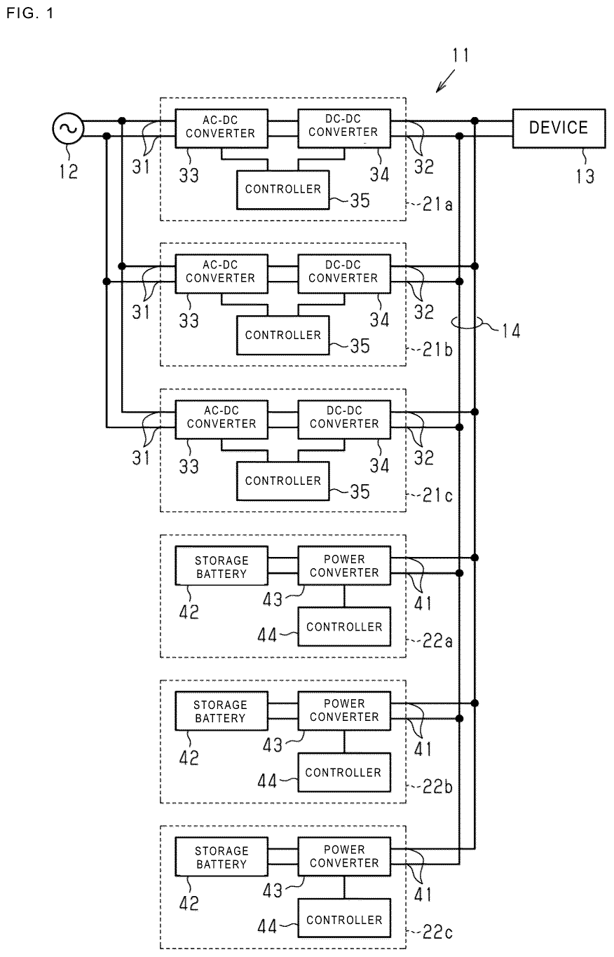

As illustrated in FIG. 1, a power supply system 11 of the first embodiment includes three power supply units 21a, 21b, and 21c and three battery units 22a, 22b, and 22c. The power supply system 11 may include one, two, or four or more power supply units. The power supply system 11 may include one, two, or four or more battery units.

The power supply units 21a to 21c each are coupled to an AC power supply 12. The AC power supply 12 is, for example, a commercial power system and the like. The power supply units 21a to 21c are coupled in parallel. The power supply units 21a to 21c each are coupled to a device 13. The device 13 is supplied with a DC voltage. The device 13 is, for example, a server, a storage, or the like in a data center or the like.

The power supply units 21a, 21b, and 21c each have the same configuration. The power supply units 21a to 21c each include an input terminal 31 and an output terminal 32. The input terminal 31 is configured to be coupled to the AC power supply 12. The output terminal 32 is configured to be coupled to the device 13. In the present embodiment, the output terminal 32 is coupled to a power supply line 14 to which the device 13 is coupled. It can be said that the power supply units 21a to 21c are coupled in parallel with the power supply line 14. Further, it can be said that the power supply units 21a to 21c are coupled to the device 13 in parallel with the power supply line 14. The power supply units 21a to 21c are configured to convert input power into DC power and to output the DC power to the output terminal 32.

The power supply units 21a to 21c each include an AC-DC converter 33, a DC-DC converter 34, and a controller 35. The controller 35 controls the AC-DC converter 33 and the DC-DC converter 34. The AC-DC converter 33 converts an AC voltage of the AC power supply 12 into a DC voltage. The DC-DC converter 34 converts the DC voltage outputted from the AC-DC converter 33 into a DC voltage to fit to the device 13.

The power supply units 21a to 21c each have output characteristics (droop characteristics) in which an output voltage varies depending on an output current. Consumption power of the device 13 such as a server varies depending on an amount of information processing. The consumption power of the device 13 is a load for the power supply units 21a to 21c. Accordingly, the load of the power supply units 21a to 21c varies depending on an operation of the device 13.

The battery units 22a to 22c each have the same configuration. The battery units 22a to 22c each have a first coupling terminal 41. The first coupling terminal 41 is configured to be coupled to the power supply units 21a to 23a. In the present embodiment, the first coupling terminal 41 is coupled to the power supply line 14. The output terminal 32 of each of the power supply units 21a to 21c and the device 13 are coupled to the power supply line 14. It can be said that the first coupling terminal 41 is coupled to each of the output terminals 32 of the power supply units 21a to 21c and the device 13. Further, it can be said that the battery units 22a to 22c are coupled to the power supply units 21a to 21c in parallel. The power supply units 21a to 21c are coupled to the device 13. It can be said that the battery units 22a to 22c are coupled to the device 13 in parallel.

As described above, the power supply units 21a to 21c, the battery units 22a to 22c, and the device 13 are coupled to the power supply line 14. It can be said that the power supply line 14 is a bus that couples the power supply units 21a to 21c, the battery units 22a to 22c, and the device 13. The voltage of the power supply line 14 may be referred to as a bus voltage.

The battery units 22a to 22c each include a storage battery (battery) 42, a power converter 43, and a controller 44. The storage battery 42 is a chargeable and dischargeable battery (secondary battery). The storage battery 42 is, for example, a lithium-ion battery. The power converter 43 is configured to be able to convert a terminal voltage of the first coupling terminal 41 of each of the battery units 22a to 22c. The power converter 43 is configured to be able to convert a voltage of the storage battery 42.

The power converter 43 generates a charging current for charging the storage battery 42 with the terminal voltage of the first coupling terminal 41 of each of the battery units 22a to 22c. The power converter 43 has a function of converting the voltage of the storage battery 42 into an output voltage of the first coupling terminal 41. The power converter 43 is configured of, for example, a bidirectional DC-DC converter. The controller 44 controls the power converter 43.

### (Battery Unit)

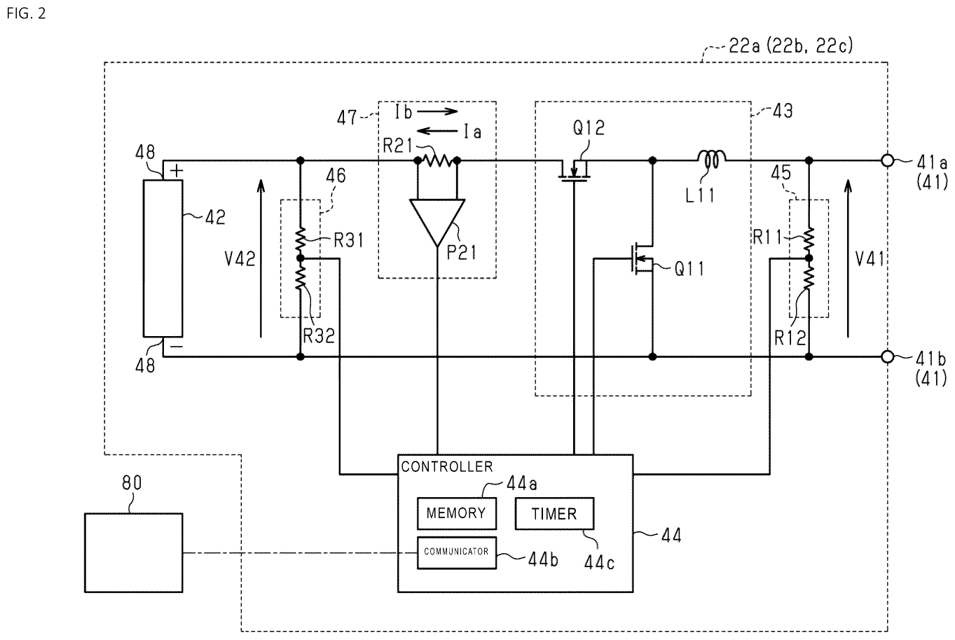

FIG. 2 illustrates an electrical configuration of the battery unit 22a (22b, 22c).

The battery unit 22a includes the power converter 43, the controller 44, voltage detectors 45 and 46, and a current detector 47. The battery unit 22a has a second coupling terminal 48 configured to be coupled to the storage battery 42. The second coupling terminal 48 may be configured of, for example, a terminal coupled to a terminal of the storage battery 42, an end portion of a cable, or the like. The second coupling terminal 48 may be provided between the storage battery 42 and the power converter 43.

The voltage detector 45 is coupled to the first coupling terminal 41 (between first coupling terminals 41a and 41b). The voltage detector 45 detects a voltage proportional to a terminal voltage V41 of the first coupling terminal 41 (between first coupling terminals 41a and 41b). The voltage detector 45 includes resistors R11 and R12. The resistors R11 and R12 are coupled in series between the first coupling terminals 41a and 41b. The voltage detector 45 is a voltage dividing circuit formed of the resistors R11 and R12. The voltage detector 45 outputs a voltage obtained by dividing a terminal voltage V41 between the first coupling terminals 41a and 41b with the resistors R11 and R12. Thus, it can be said that the voltage detector 45 detects the terminal voltage V41 of the first coupling terminal 41 (between first coupling terminals 41a and 41b). The voltage of the voltage detector 45 is inputted to the controller 44. Thus, it can be said that the controller 44 is configured to be able to measure the terminal voltage V41. The first coupling terminal 41 is coupled to the power supply line 14 illustrated in FIG. 1. As described above, the power supply line 14 may be referred as a bus. The terminal voltage V41 at the first coupling terminal 41 and a bus voltage of the power supply line 14 are equal. Here, “voltages are equal” is not limited to multiple voltage values being exactly equal, and includes multiple voltage values being substantially equal. Accordingly, it can be said that the voltage detector 45 detects the bus voltage.

The power converter 43 is coupled between the first coupling terminal 41 and the second coupling terminal 48. The power converter 43 includes an inductor L11 and switching elements Q11 and Q12. A first terminal of the inductor L11 is coupled to the first coupling terminal 41a. A second terminal of the inductor L11 is coupled to the switching elements Q11 and Q12. The switching elements Q11 and Q12 each are, for example, an N-channel FET. A source of the switching element Q12 and a drain of the switching element Q11 are coupled to the inductor L11. A source of the switching element Q11 is coupled to the first coupling terminal 41b. Gates of the switching elements Q11 and Q12 each are coupled to the controller 44. A drain of the switching element Q12 is coupled to the current detector 47.

The controller 44 outputs a control signal to each gate of the switching elements Q11 and Q12. The switching elements Q11 and 012 each are turned on and off in response to the control signal. The power converter 43 operates as a step-up DC-DC converter from the first coupling terminal 41 toward the storage battery 42. The power converter 43 operates as a step-down DC-DC converter from the storage battery 42 toward the first coupling terminal 41. The controller 44 adjusts a duty ratio of the control signal. The duty ratio adjusts an ON time and an OFF time of each of the switching elements Q11 and 012, and adjusts an output voltage of the power converter 43.

The current detector 47 is coupled between the power converter 43 and the second coupling terminal 48. The current detector 47 detects a charging current Ia flowing toward the storage battery 42 and a discharging current Ib discharged from the storage battery 42. The current detector 47 includes a resistor R21 and an operational amplifier P21. A first terminal of the resistor R21 is coupled to the switching element Q12, and a second terminal of the resistor R21 is coupled to a high potential side terminal (positive terminal) of the storage battery 42. A low potential side terminal (negative terminal) of the storage battery 42 is coupled to the first coupling terminal 41. Input terminals of the operational amplifier P21 are coupled to both terminals of the resistor R21, respectively. The resistor R21 generates a potential difference between both terminals by a current flowing through the resistor R21. The operational amplifier P21 outputs a voltage proportional to a potential difference generated in the resistor R21, that is, a current flowing through the resistor R21. The potential difference generated between both terminals of the resistor R21 depends on an amount and a direction of a current flowing through the resistor R21. Accordingly, the current detector 47 detects the charging current Ia or the discharging current Ib flowing through the resistor R21 and the amount of the current based on an output voltage of the operational amplifier P21. The output voltage of the operational amplifier P21 is inputted to the controller 44. Thus, it can be said that the controller 44 is configured to be able to measure the charging current Ia. Further, it can be said that the controller 44 is configured to be able to measure the discharging current Ib.

The voltage detector 46 is coupled between both terminals of the storage battery 42. The voltage detector 46 detects a voltage proportional to an inter-terminal voltage V42 of the storage battery 42. The voltage detector 46 includes resistors R31 and R32. The resistors R31 and R32 are coupled in series between both terminals of the storage battery 42. The voltage detector 46 is a voltage dividing circuit formed of the resistors R31 and R32. The voltage detector 46 outputs a voltage obtained by dividing the inter-terminal voltage V42 of the storage battery 42 with the resistors R31 and R32. Thus, it can be said that the voltage detector 46 detects the inter-terminal voltage V42 of the storage battery 42. The voltage of the voltage detector 46 is inputted to the controller 44. Thus, it can be said that the controller 44 is configured to be able to measure the voltage V42 of the storage battery 42.

The controller 44 includes a memory 44a, a communicator 44b, and a timer 44c.

The memory 44a is configured to be able to memorize at least one piece of information. The information memorized in the memory 44a includes a first threshold value for the terminal voltage V41.

The first threshold value is set in accordance with a change or a variation of the terminal voltage V41 that changes because of output characteristics of each of the power supply units 21a to 21c illustrated in FIG. 1. The information in the memory 44a may be set in advance or may be set with a setting terminal 80 described later. The information in the memory 44a may be set using a portable recording medium such as a memory card. Further, part of the memory 44a may be configured by a portable recording medium.

The communicator 44b is configured to be able to communicate with the setting terminal 80. The communication between the communicator 44b and the setting terminal 80 may be either wired communication or wireless communication.

The setting terminal 80 is used to set information in the memory 44a. For the setting terminal 80, a portable information terminal such as a notebook personal computer, a tablet, or a smartphone, for example, may be used. The controller 44 lets the memory 44a memorize information received from the setting terminal 80 through the communicator 44b. The information received through the communicator 44b includes the first threshold value described above. The first threshold value is set in accordance with a rated output power (rated output voltage) of each of the power supply units 21a to 21c. The first threshold value is set in accordance with an output voltage assuming each of the power supply units 21a to 21c becomes overcurrent. For example, the first threshold value is set to a value (intermediate value, for example) between the rated output voltage and an output voltage at a time of overcurrent of each of the power supply units 21a to 21c.

The communicator 44b may be used to transmit information (various kinds of information memorized in memory 44a, for example) of the controller 44 to the outside. For example, the controller 44 transmits the information memorized in the memory 44a through the communicator 44b in response to a request from the setting terminal 80. The setting terminal 80 receives the information transmitted from the communicator 44b. Thus, the state of the battery unit 22a (22b, 22c) may be confirmed with the setting terminal 80.

The timer 44c is, for example, a timer device for obtaining an elapsed time. The controller 44 starts and stops the timer 44c. The controller 44 obtains the elapsed time and the like from the timer 44c (count value).

### (Control of Battery Unit)

(Discharging from Storage Battery)

The controller 44 controls the power converter 43 to flow the charging current Ia, and charges the storage battery 42. For example, the controller 44 charges the storage battery 42 by a constant current constant voltage (CCCV) charging method that manages the charging current Ia and the terminal voltage V41 for the storage battery 42. The controller 44 controls the power converter 43 to generate the terminal voltage V41 of the first coupling terminal 41 to fit to the voltage of the device 13, from the discharging current Ib of the storage battery 42.

### (Charging of Storage Battery)

The controller 44 obtains an electricity storage amount of the storage battery 42. The electricity storage amount of the storage battery 42 is indicated by, for example, the inter-terminal voltage V42 of the storage battery 42. The electricity storage amount may be indicated by a state of charge (SOC) of the storage battery 42. The controller 44 charges the storage battery 42 with a predetermined charging method based on the electricity storage amount of the storage battery 42, assuming the electricity storage amount is equal to or less than a predetermined value. The charging method is, for example, a constant current constant voltage (CCCV) charging method. Note that other methods may be used as the charging method. The controller 44 controls the power converter 43 to charge the storage battery 42 to a predetermined electricity storage amount with a predetermined constant current (CC), and then to charge the storage battery 42 with a predetermined constant voltage (CV).

The controller 44 memorizes a CC target value of the constant current control and a CV target value of the constant voltage control in the memory 44a. In the constant current control, the controller 44 sets a current value of the charging current detected by the current detector 47 as a CC measurement value, and calculates a charging control amount from the CC target value and the CC measurement value. For the calculation of the charging control amount, a calculation method such as P calculation, PI calculation, or PID calculation, for example, may be used. The controller 44 controls the power converter 43 with the calculated charging control amount. Thus, the controller 44 controls the power converter 43 such that the charging current Ia matches the CC target value. That is, the controller 44 performs control to feed back the charging current Ia.

The controller 44 memorizes the CV target value of the constant voltage control in the memory 44a. In the constant voltage control, the controller 44 sets the inter-terminal voltage V42 of the storage battery 42 detected by the voltage detector 46 as a CV measurement value, and calculates a charging control amount from the CV target value and the CV measurement value. For the calculation of the charging control amount, a calculation method such as P calculation, PI calculation, or PID calculation, for example, may be used. The controller 44 controls the power converter 43 with the calculated charging control amount. Thus, the controller 44 controls the power converter 43 such that the inter-terminal voltage V42 matches the CV target value. That is, the controller 44 performs control to feed back the inter-terminal voltage V42.

Further, in a state that the charging current Ia is flowing, the controller 44 controls the power converter 43 to adjust the charging current Ia to the storage battery 42 based on the terminal voltage V41 (bus voltage).

The controller 44 compares the terminal voltage V41 of the first coupling terminal 41 and the first threshold value memorized in the memory 44a. The controller 44 controls the power converter 43 to supply the charging current Ia to the storage battery 42 assuming the terminal voltage V41 is larger than the first threshold value.

In a state that the charging current Ia is flowing, the controller 44 compares the terminal voltage V41 and the first threshold value, and controls the power converter 43 to decrease the charging current Ia from a time T11 assuming the terminal voltage V41 crosses the first threshold value to a time T16 assuming the terminal voltage V41 crosses the first threshold value again. Crossing the first threshold value of the terminal voltage V41 corresponds to the terminal voltage V41 falling below the first threshold value. Crossing the first threshold value again of the terminal voltage V41 corresponds to the terminal voltage V41 exceeding the first threshold value. That is, in a state that the charging current Ia is flowing, the controller 44 controls the power converter 43 to decrease the charging current Ia from the time T11 (first time) assuming the terminal voltage V41 falls below the first threshold value to the time T16 assuming the terminal voltage V41 exceeds the first threshold value.

The controller 44 controls the power converter 43 to gradually decrease the charging current Ia assuming the terminal voltage V41 crosses (falls below) the first threshold value.

As described above, the controller 44 controls the power converter 43 with a constant current constant voltage (CCCV) charging method, for example, and supplies the charging current Ia to the storage battery 42. The controller 44 adjusts the CC target value based on the terminal voltage V41 and the first threshold value. The controller 44 calculates a charging control amount from an adjusted CC target value and the CC measurement value, and controls the power converter 43 with the charging control amount. Note that the controller 44 may adjust the CV target value based on the terminal voltage V41 and the first threshold value.

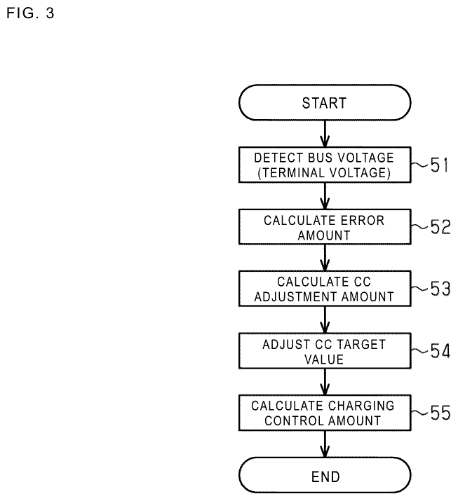

The adjustment of the CC target value will be described with reference to the flowchart illustrated in FIG. 3. FIG. 3 illustrates part of processes, executed by the controller 44, which is related to the adjustment of the charging amount for the storage battery 42. The controller 44 repeatedly executes processes illustrated in FIG. 3 at predetermined intervals.

In step 51, the controller 44 detects the terminal voltage V41 as the bus voltage.

In step 52, the controller 44 calculates an error amount from the bus voltage (terminal voltage V41) and the bus control threshold value (first threshold value). For example, the controller 44 calculates a difference between the terminal voltage V41 and the first threshold value as the error amount.

In step 53, the controller 44 calculates the CC adjustment amount from the error amount. For the calculation of the CC adjustment amount, a calculation method such as P calculation, PI calculation, or PID calculation, for example, may be used.

In step 54, the controller 44 adjusts the CC target value by subtracting the calculated CC adjustment amount from the CC target value.

In step 55, the controller 44 calculates the charging control amount from the adjusted CC target value and the amount of the charging current Ia being the CC measurement value. The controller 44 controls the power converter 43 based on the charging control amount.

By the processes in steps 51 to 55, the controller 44 controls the power converter 43 such that the terminal voltage V41, being the bus voltage, becomes equal to the first threshold value, being the bus control threshold value. Assuming the terminal voltage V41 (bus voltage) lowers, the controller 44 lowers the CC target value based on the difference (error amount) between the terminal voltage V41 and the first threshold value, thereby decreasing the charging current Ia.

In each of the battery units 22a to 22c, the power converter 43 generates the charging current Ia from the terminal voltage V41 of the first coupling terminal 41, and charges the storage battery 42 with the charging current Ia. The control of the charging current Ia, that is, increase or decrease the charging current Ia, is increase or decrease the consumption power in each of the battery units 22a to 22c. This results in increase or decrease the load of each of the power supply units 21a to 21c, and appears as a change of the output voltage of each of the power supply units 21a to 21c because of the output characteristics of each of the power supply units 21a to 21c. The output voltage of each of the power supply units 21a to 21c is the bus voltage of the power supply line 14 (bus line) coupling the power supply units 21a to 21c and the battery units 22a to 22c, and is also the terminal voltage V41 of each of the battery units 22a to 22c. The voltage detector 45 of each of the battery units 22a to 22c detects the terminal voltage V41. That is, it can be said that each of the battery units 22a to 22c adjusts the terminal voltage V41 by controlling the charging current Ia based on the terminal voltage V41. Further, it can be said that each of the battery units 22a to 22c controls the bus voltage (terminal voltage V41) with the feedback of the bus voltage (terminal voltage V41).

### (Operation)

Next, the operation of the power supply system 11 will be described.

In each of the battery units 22a to 22c, the power converter 43 converts the voltage of the storage battery 42 into the output voltage of the first coupling terminal 41. That is, the battery unit 22a discharges from the storage battery 42 toward the first coupling terminal 41. The discharging current Ib from the storage battery 42, that is, an output power of the battery units 22a to 22c is supplied to the device 13. Accordingly, the device 13 operates with an output power of the power supply units 21a to 21c and the output power of the battery units 22a to 22c. Assuming the consumption power of the device 13 exceeds the output power of the power supply units 21a to 21c, the device 13 may be operated by supplying power from the battery units 22a to 22c. Further, by supplying power from the battery units 22a to 22c, overcurrent in the power supply units 21a to 21c may be suppressed.

During charging of the storage battery 42, that is, in a state that the charging current Ia is flowing toward the storage battery 42, the load of the power supply units 21a to 21c is the sum of the load (consumption power) caused by the device 13 and the load (consumption power) caused by the battery units 22a to 22c during charging. In the state above, assuming the processing amount of the device 13 increases, the consumption power of the device 13 increases, that is, the load of the power supply units 21a to 21c increases. Because of this increasing the load, the output current of the power supply units 21a to 21c becomes overcurrent equal to or larger than the rated current of the power supply units 21a to 21c. The controller 44 of each of the battery units 22a to 22c adjusts the charging current Ia, thereby suppressing the occurrence of overcurrent in the power supply units 21a to 21c. This will be described in detail below.

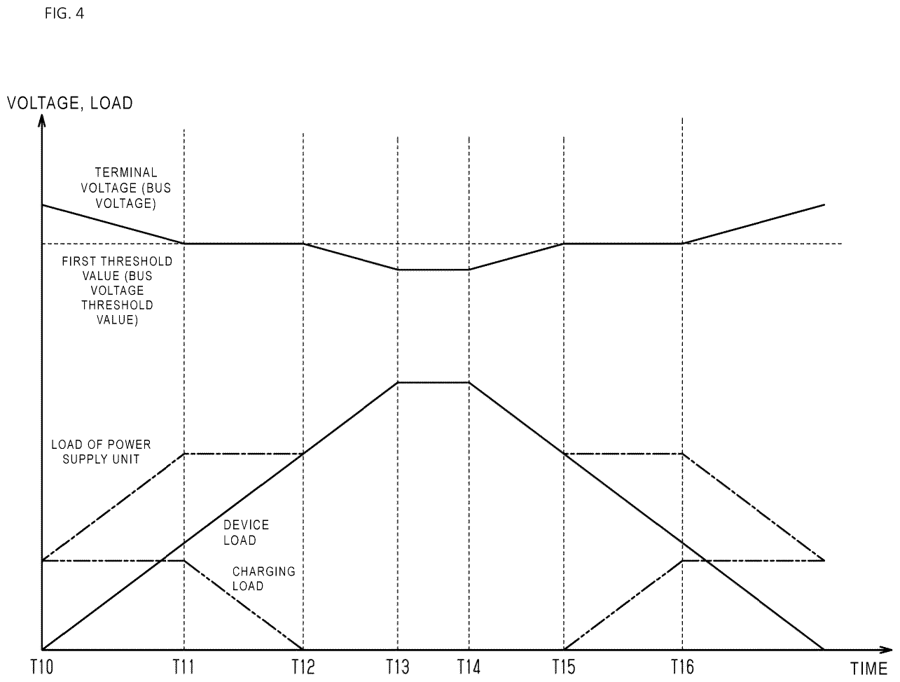

FIG. 4 illustrates control assuming the charging current Ia is flowing in the power supply system 11 of a first embodiment. In FIG. 4, a horizontal axis represents time, and a vertical axis represents an amount of voltage and load. In the upper stage of FIG. 4, a solid line indicates the terminal voltage V41 (bus voltage). In the lower stage of FIG. 4, a solid line indicates a load (device load) caused by the device 13, a dashed-and-dotted line indicates a load of a power supply unit, and a dashed-and-double-dotted line indicates a load (charging load) related to charging in a battery unit. For convenience of description, one power supply unit 21a and one battery unit 22a will be described.

The load caused by the device 13 increases from a time T10 in FIG. 4. In the case above, the load of the power supply unit 21a increases, and the bus voltage (terminal voltage V41), which is the output voltage of the power supply unit 21a, decreases in accordance with the output characteristics of the power supply unit 21a.

At the time T11, assuming the bus voltage (terminal voltage V41) crosses the bus control threshold value (first threshold value), the controller 44 controls the power converter 43 to decrease the charging current Ia supplied to the storage battery 42. This reduces the load caused by charging the battery unit 22a.

The controller 44 of the battery unit 22a calculates the charging control amount of the power converter 43 to generate the charging current Ia, based on an error amount calculated from the terminal voltage V41 (bus voltage) and the first threshold value (bus control threshold value). The controller 44, then, controls the power converter 43 such that the terminal voltage V41 becomes equal to the first threshold value. This suppresses an increase the load of the power supply unit 21a. That is, overcurrent in the power supply unit 21a is suppressed.

At a time T12 in FIG. 4, assuming the charging current Ia for the battery unit 22a becomes 0 (zero), the load of the power supply unit 21a increases following the increasing the load caused by the device 13. The output voltage (bus voltage) of the power supply unit 21a lowers.

At a time T13 in FIG. 4, assuming the load caused by the device 13 becomes stable (processing amount of device 13 becomes stable), the load of the power supply unit 21a also becomes stable.

At a time T14 in FIG. 4, assuming the load caused by the device 13 reduces (processing amount of device 13 decreases), the load of the power supply unit 21a also reduces. The output voltage (bus voltage) of the power supply unit 21a, then, rises.

At a time T15 in FIG. 4, the controller 44 of the battery unit 22a starts to supply the charging current Ia again based on an error amount calculated from the terminal voltage V41 and the first threshold value. Thus, the load of the power supply unit 21a becomes stable.

At the time T16 in FIG. 4, assuming the bus voltage (terminal voltage V41) crosses the bus control threshold value (first threshold value) again, the controller 44 stops the control for increasing the charging current Ia to supply to the storage battery 42. That is, the controller 44 controls the power converter 43 such that the charging current Ia is in accordance with the electricity storage amount of the storage battery 42, regardless of the terminal voltage V41.

The operation described above is the same for each of other power supply units 21b and 21c, and the overcurrent in each of the power supply units 21b and 21c may be suppressed. The operation of the battery unit 22a is the same even assuming other battery units 22b and 22c each are in the charging state. Further, the operation of the battery unit 22a is the same even assuming two or more battery units are in the charging state at the same time.

In the power supply system 11 of the first embodiment illustrated in FIG. 1, three power supply units 21a to 21c are coupled to the device 13 in parallel. In the power supply system 11, for example, due to variations in characteristics of the power supply units 21a to 21c, a current may be concentrated to one power supply unit, for example, to the power supply unit 21a, and an overcurrent state may occur. In the power supply unit 21a in the overcurrent state as described above, heat generation may become large. However, since the battery units 22a to 22c coupled to the power supply units 21a to 21c in parallel each decrease the charging current Ia, the overcurrent in the power supply unit, to which a current is concentrated, may be suppressed. Note that the effect of suppressing the overcurrent may similarly be obtained in a power supply system including one battery unit 22a. That is, one or more battery units may be provided.

### (Confirmation of Operation)

Next, a method of confirming the operation of the battery units 22a to 22c will be described.

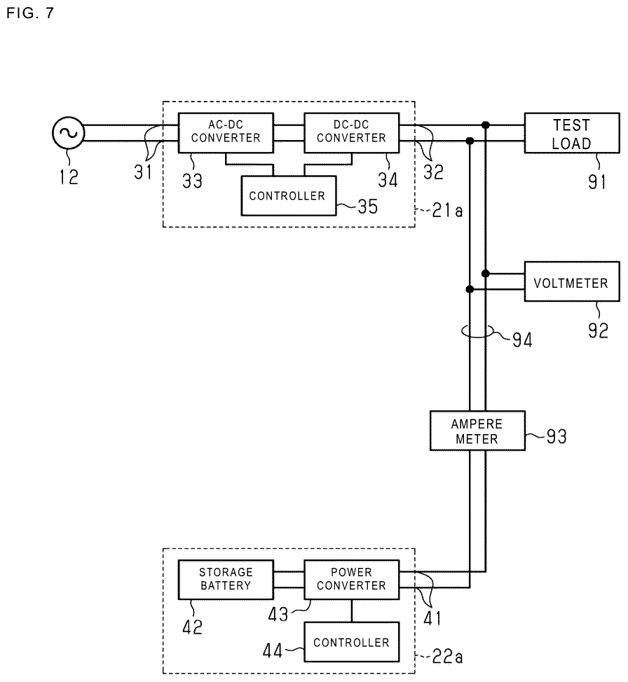

FIG. 7 illustrates a coupling state in the operation confirmation. Note that one battery unit 22a is illustrated in FIG. 7.

The first coupling terminal 41 of the battery unit 22a is coupled to the output terminal 32 of the power supply unit 21a with a power supply line 94 for testing. A test load 91, a voltmeter 92, and an ampere meter 93 are coupled to the power supply line 94. The test load 91 is configured such that a load current and a load voltage are variable and measurable. The voltmeter 92 is configured to be able to measure a voltage value of the power supply line 94, that is, the terminal voltage V41 of the first coupling terminal 41 of the battery unit 22a. The ampere meter 93 is configured to be able to measure a current flowing through the power supply line 94, that is, a current flowing toward the battery unit 22a in the operation confirmation.

In the configuration described above, the storage battery 42 of the battery unit 22a is charged, that is, a current flows from the power supply unit 21a toward the battery unit 22a. At this time, the ampere meter 93 measures the value of the current flowing through the power supply line 94 in accordance with the charging current Ia (see FIG. 2) for the storage battery 42 in the battery unit 22a. In the state above, the load current caused by the test load 91 is increased while monitoring the terminal voltage V41 of the voltmeter 92 and the current value of the ampere meter 93. At this time, assuming the current value of the ampere meter 93 decreases at a certain terminal voltage value V1, it can be confirmed that control for decreasing the charging current Ia for the storage battery 42 is performed at the terminal voltage value V1, that is, the battery unit 22a is normally operated. On the other hand, assuming the current value of the ampere meter 93 does not decrease regardless of an increase the load current caused by the test load 91 and the output current of the power supply unit 21a becomes overcurrent, it can be confirmed that an abnormality is occurring in the battery unit 22a.

Hereinbefore, the operation confirmation of one battery unit 22a has been described. In addition to that, the operation confirmation can be performed in the same manner for three battery units 22a to 22c as illustrated in FIG. 1, and two or four or more battery units.

The operation confirmation described above can be performed on a battery unit other than the battery units 22a to 22c described above. Instead of the battery unit 22a illustrated in FIG. 7, another battery unit is coupled to the power supply line 94. In the state above, the load current caused by the test load 91 is increased while monitoring the voltage value of the voltmeter 92 and the current value of the ampere meter 93. At this time, assuming the current value of the ampere meter 93 decreases at a certain voltage value, it may be determined that control of decreasing a charging current for the storage battery is being performed in the other battery unit at that voltage value. That is, it can be determined that the other battery unit has the same configuration as the battery unit 22a of the embodiment.

### (Effects)

As described above, the power supply system 11 of the first embodiment exhibits the following effects.
(1-1) The power supply system 11 includes the power supply units 21a to 21c and the battery units 22a to 22c. The battery unit 22a includes the first coupling terminal 41, the second coupling terminal 48 configured to be coupled to the storage battery 42, the power converter 43 coupled between the first coupling terminal 41 and the second coupling terminal 48, and the controller 44 configured to control the power converter 43 and to measure the terminal voltage V41 of the first coupling terminal 41 and the current Ia flowing from the power converter 43 to the second coupling terminal 48. The controller 44 compares the terminal voltage V41 and the first threshold value in a state that the current Ia is flowing from the power converter 43 to the second coupling terminal 48. Assuming the terminal voltage V41 crosses the first threshold value, the controller 44 controls the power converter 43 such that the current Ia flowing from the power converter 43 to the second coupling terminal 48 is decreased until the terminal voltage V41 crosses the first threshold value again.

The terminal voltage V41 is a voltage (bus voltage) of a bus (power supply line 14) coupling the battery units 22a to 22c, the power supply units 21a to 21c, and the device 13, and is an output voltage of the power supply units 21a to 21c. The power supply units 21a to 21c each have output characteristics in which the output voltage changes in accordance with an output current. An increasing load because of an operating state of the device 13 leads to an increase in the output current of the power supply units 21a to 21c, and thus, the power supply units 21a to 21c become overcurrent. Decreasing the charging current Ia in the battery units 22a to 22c reduces the load of the power supply units 21a to 21c caused by the battery units 22a to 22c. Accordingly, by decreasing a charging current in the battery units 22a to 22c, an increase the load of the power supply units 21a to 21c is suppressed. Thus, in the power supply units 21a to 21c, overcurrent due to a load variation may be suppressed.
(1-2) In a state that the charging current Ia is flowing, the controller 44 of each of the battery units 22a to 22c compares the terminal voltage V41 and the first threshold value, and controls the power converter 43 to decrease the charging current Ia. The terminal voltage V41 is an output voltage of the power supply units 21a to 21c. The output voltage of the power supply units 21a to 21c changes in accordance with the loads thereof. Accordingly, the controller 44 of each of the battery units 22a to 22c may detect a load state of the power supply units 21a to 21c with the terminal voltage V41. The battery units 22a to 22c may not require a wiring line or a circuit for performing communication of, for example, a request signal or the like. That is, the battery units 22a to 22c may suppress overcurrent in the power supply units 21a to 21c with a simple configuration.
(1-3) The power supply system 11 includes the power supply units 21a to 21c coupled in parallel. In the power supply system 11, for example, due to variations in characteristics of the power supply units 21a to 21c, a current may be concentrated to one power supply unit, for example, to the power supply unit 21a, and an overcurrent state may occur. In the power supply unit 21a in the overcurrent state as described above, heat generation may become large. However, the battery units 22a to 22c coupled to the power supply units 21a to 21c in parallel each decrease the charging current Ia, and thus, overcurrent in the power supply unit, to which a current is concentrated, may be suppressed.
(1-4) The power supply system includes the power supply units 21a to 21c and the battery units 22a to 22c. The power supply units 21a to 21c supply power to the device 13 such as a server. The battery units 22a to 22c each supply power to the device 13 by discharging the storage battery 42.

Consumption power (load) of the device 13 such as a server changes depending on a processing amount. Rated power (power supply capacity) of the power supply units 21a to 21c may be set larger than the maximum consumption power (peak load) of the device 13. The setting above leads to an increase in size of the power supply units 21a to 21c. In contrast, the power supply system 11 of the first embodiment supplies power to the device 13 from the power supply units 21a to 21c and the battery units 22a to 22c. Thus, an increase in size of the power supply units 21a to 21c may be suppressed.

### Modification of First Embodiment

In the first embodiment, after the terminal voltage V41 crosses the first threshold value, the charging current Ia is decreased until the terminal voltage V41 crosses the first threshold value again, but is not limited thereto. For example, a first value and a second value which are values within a voltage range including the first threshold value (range of ±30% of first threshold value, for example) are set as the first threshold value. Assuming the terminal voltage V41 varies in a predetermined direction, the terminal voltage V41 is compared with the first value. Assuming the terminal voltage V41 varies in a direction opposite to the predetermined direction, the terminal voltage V41 is compared with the second value. That is, the controller 44 controls the power converter 43 to decrease the charging current Ia from the time assuming the terminal voltage V41 varies in a predetermined direction and crosses the first value to the time assuming the terminal voltage V41 varies in the direction opposite to the predetermined direction and crosses the second value. Varying in the predetermined direction and crossing the first value of the terminal voltage V41 mean that the terminal voltage V41 falls below the first value. Varying in the direction opposite to the predetermined direction and crossing the second value of the terminal voltage V41 mean that the terminal voltage V41 exceeds a second threshold value. The first value and the second value may be the same value, or the first value and the second value may be different values. The second value may be a value lower than the first value or may be a value higher than the first value. Even assuming the first value and the second value are used as described above, the same effect as that of the first embodiment may be obtained. The first value and the second value may be set for at least one of the battery units 22a to 22c described above. That is, the power supply system may include a battery unit controlled by the first threshold value and a battery unit controlled by the first value and the second value.

### Second Embodiment

A second embodiment will be described below.

A power supply system 11 of the second embodiment is different from the power supply system 11 of the first embodiment in control assuming a charging current is flowing. A configuration of the power supply system of the second embodiment, therefore, will be described using the same names and reference signs as the configuration of the power supply system 11 of the first embodiment, and drawings related to the configuration will be omitted. The configuration of the power supply system 11 will be described with reference to FIG. 1 and FIG. 2.

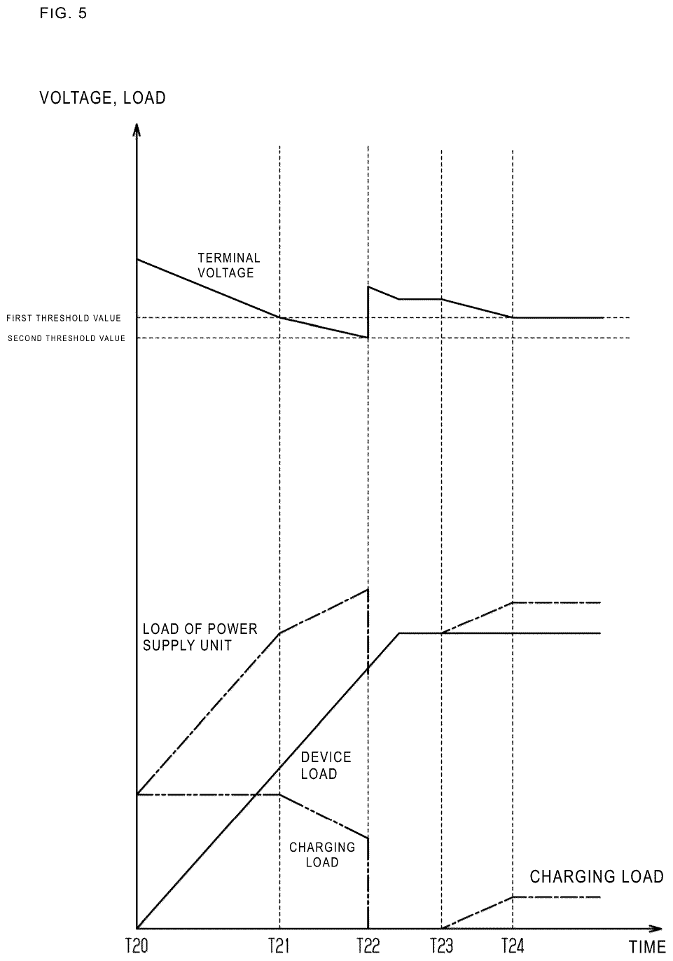

FIG. 5 illustrates control assuming the charging current Ia is flowing in the power supply system 11 of the second embodiment. In FIG. 5, a horizontal axis represents time, and a vertical axis represents an amount of voltage and load. In the upper stage of FIG. 5, a solid line indicates the terminal voltage V41 (bus voltage). In the lower stage of FIG. 5, a solid line indicates a load (device load) caused by the device 13, a dashed-and-dotted line indicates a load of a power supply unit, and a dashed-and-double-dotted line indicates a load (charging load) related to charging in the battery unit. For convenience of description, one power supply unit 21a and one battery unit 22a will be described as in the first embodiment.

The memory 44a illustrated in FIG. 2 memorizes the second threshold value in addition to the first threshold value. The second threshold value is set to a value lower than the first threshold value. For example, the second threshold value is set to a value between the first threshold value and an output voltage at the time of overcurrent (intermediate value, for example).

As in the first embodiment, the controller 44 compares the terminal voltage V41 (bus voltage) of the first coupling terminal 41 and the first threshold value, and controls the power converter 43 to gradually decrease the charging current Ia from a time T21 assuming the terminal voltage V41 crosses the first threshold value. The controller 44 compares the terminal voltage V41 (bus voltage) and the second threshold value. The controller 44 controls the power converter 43 such that the charging current Ia becomes 0 (zero) at a time T22 assuming the terminal voltage V41 crosses the second threshold value. Here, “crossing the second threshold value” has the same meaning as “crossing the first threshold value”.

As illustrated in FIG. 2, the power converter 43 includes the switching elements Q11 and Q12. The controller 44 adjusts an ON time and an OFF time of each of the switching elements Q11 and 012 based on the charging control amount, thereby gradually decreasing the charging current Ia. The controller 44 outputs a control signal for turning off the switching elements Q11 and Q12. As a result, the charging current Ia does not flow toward the storage battery 42, that is, the charging current Ia becomes 0 (zero). As described above, the controller 44 controls the power converter 43 such that the charging current Ia becomes 0.

The load caused by the device 13 increases from a time T20 in FIG. 5. As illustrated in FIG. 5, assuming the increasing the load caused by the device 13 is large, the load of the power supply unit 21a may stay unstable even assuming the power converter 43 is controlled to gradually decrease the charging current Ia. In the case above, the terminal voltage V41 (bus voltage) further decreases from the value at the time T21 (first time). The controller 44 controls the power converter 43 to make the charging current Ia 0 (zero) assuming the lowering terminal voltage V41 (bus voltage) crosses the second threshold value. Thus, the controller 44 further reduces the load for the charging of the storage battery 42 than at the time of the first threshold value.

As illustrated at the time T22 in FIG. 5, the power converter 43 is controlled such that the charging current Ia becomes 0 (zero). At this time, since the load of the power supply unit 21a rapidly reduces, the terminal voltage V41 (bus voltage) rapidly rises. The rising terminal voltage V41 exceeds the first threshold value. That is, the terminal voltage V41 crosses the first threshold value again. Assuming charging of the storage battery 42 is resumed because of the change in the terminal voltage V41, the load of the power supply unit 21a rapidly increases by the charging. The terminal voltage V41, then, crosses the first and second threshold values, and since the charging current Ia for the storage battery 42 is controlled in response to that, the load of the power supply unit 21a rapidly decreases. That is, the load of the power supply unit 21a may rapidly decrease and rapidly increase repeatedly.

In contrast, the controller 44 invalidates comparison between the terminal voltage V41 (bus voltage) and the first threshold value and comparison between the terminal voltage V41 and the second threshold value for a predetermined first period from the time T22 assuming the terminal voltage V41 (bus voltage) crosses the second threshold value. The predetermined first period is set to a period until a temporary load increase disappears, based on a recorded result of a load variation because of the operation of the device 13, for example. The predetermined first period may be changed depending on a state of a load variation (rate of increasing load (decreasing terminal voltage V41), value of terminal voltage V41 assuming load becomes stable, and the like) because of the operation of a device. As described above, by invalidating the comparison for determination between the terminal voltage V41 and each of the first and second threshold values, repeated rapid increasing and rapid decreasing the load of the power supply unit may be suppressed.

In the example illustrated in FIG. 5, after the charging current Ia is made 0 (zero) at the time T22, the load caused by the device 13 becomes stable. This stabilizes the load of the power supply unit 21a. The controller 44 may determine that the load becomes stable from the change in the terminal voltage V41. In the case above, the controller 44 may perform soft start control from a time T23 in FIG. 5. The soft start control is to control the power converter 43 so as to gradually increase the charging current Ia. At this time, the controller 44 controls the power converter 43 such that the terminal voltage V41 does not change rapidly, while monitoring the terminal voltage V41. The controller 44, then, controls the power converter 43 (after a time T24) such that the terminal voltage V41 (bus voltage) becomes equal to the first threshold value (bus control threshold value). Thus, the storage battery 42 may be charged while checking the load of the power supply unit 21a.

### (Effects)

As described above, the power supply system 11 of the second embodiment exhibits the following effects.
(2-1) The same effects as those of the power supply system 11 of the first embodiment are exhibited.
(2-2) The controller 44 controls the power converter 43 to make the charging current Ia 0 (zero) assuming the lowering terminal voltage V41 (bus voltage) crosses the second threshold value. Thus, the controller 44 further reduces the load for the charging of the storage battery 42 than at the time of the first threshold value. Accordingly, in the power supply units 21a to 21c, overcurrent due to a load variation may be suppressed.
(2-3) The controller 44 invalidates the comparison between the terminal voltage V41 (bus voltage) and the first threshold value and the comparison between the terminal voltage V41 and the second threshold value for a predetermined first period from the time T22 assuming the terminal voltage V41 (bus voltage) crosses the second threshold value. The predetermined first period is set to a period until a temporary load increase disappears, based on a recorded result of a load variation because of the operation of the device 13, for example. Note that the predetermined first period may be changed depending on a state of a load variation (rate of increasing load (decreasing terminal voltage V41), value of terminal voltage V41 assuming load becomes stable, and the like) because of the operation of the device. As described above, by invalidating the comparison for determination between the terminal voltage V41 and each of the first and second threshold values, repeated rapid increasing and rapid decreasing the load of the power supply unit may be suppressed.
(2-4) The controller 44 may perform soft start control. The soft start control is to control the power converter 43 so as to gradually increase the charging current Ia. At this time, the controller 44 controls the power converter 43 such that the terminal voltage V41 does not change rapidly, while monitoring the terminal voltage V41. The controller 44, then, controls the power converter 43 such that the terminal voltage V41 (bus voltage) becomes equal to the first threshold value (bus control threshold value). Thus, the storage battery 42 may be charged while checking the load of the power supply units 21a to 21c.

### (Modification)

The above embodiments may be modified as follows, for example. The above embodiments and the following modifications may be combined with each other as long as no technical contradiction occurs. In the following modifications, portions common to those in the above embodiments are denoted with the same reference signs as those in the above embodiments, and a description thereof will be omitted.

The battery units 22a to 22c of the embodiment described above each are configured to include the storage battery 42, but may be configured as a battery unit to which the storage battery 42 is coupled.

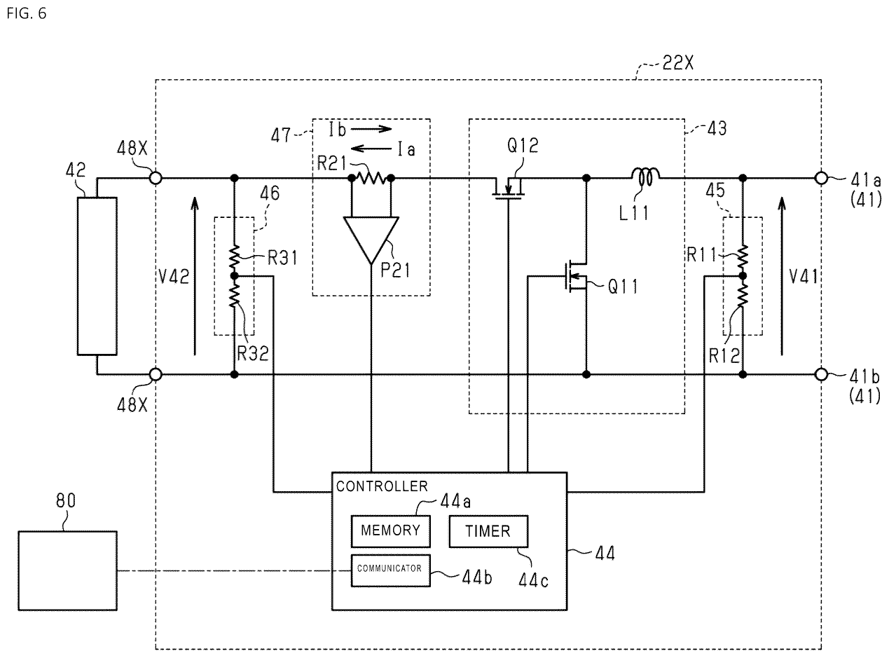

FIG. 6 illustrates a battery unit 22X of the modification. The battery unit 22X includes the power converter 43, the controller 44, the voltage detectors 45, 46, and the current detector 47. The storage battery 42 is coupled to the battery unit 22X. The battery unit 22X has a second coupling terminal 48X configured to be coupled to the storage battery 42. The second coupling terminal 48X may be a terminal provided to the battery unit 22X, an end portion of a cable drawn out from the battery unit 22X, or the like. The battery unit 22X configured as described above may also achieve the same effects as those of the embodiments described above. The battery unit 22X illustrated in FIG. 6 and at least one of the battery units 22a to 22c illustrated in FIG. 1 may be coupled to the power supply line 14 to constitute a power supply system.

In contrast to the above embodiments, the power supply units 21a to 21c, each having output characteristics in which the output voltage rises with an increase in the output current, may be used. In the case above, crossing the first threshold value of the terminal voltage V41 corresponds to the terminal voltage V41 exceeding the first threshold value. Further, crossing the first threshold value of the terminal voltage V41 again corresponds to the terminal voltage V41 falling below the first threshold value. That is, in a state that the charging current Ia is flowing, the controller 44 of each of the battery units 22a to 22c controls the power converter to decrease the charging current Ia from the time (first time) assuming the terminal voltage V41 exceeds the first threshold value to the time (second time) assuming the terminal voltage V41 falls below the first threshold value. The power supply system 11 including the power supply units 21a to 21c and the battery units 22a to 22c described above may also achieve the same effects as those of the embodiments described above.

In contrast to the above embodiments, the controller 44 may adjust the charging control amount for controlling the power converter 43 based on the calculated error amount.

A switch may be provided between the power converter 43 and the storage battery 42, and the charging current Ia may be made 0 (zero) by turning off the switch.

The controller 44 may switch from charging to discharging in response to lowering of the terminal voltage V41 (bus voltage) in a state that the charging current Ia is flowing. For example, a fourth threshold value is memorized in the memory 44a illustrated in FIG. 2. The controller 44 compares the terminal voltage V41 and the fourth threshold value, and assuming the terminal voltage V41 crosses (falls below) the fourth threshold value, the controller 44 controls the power converter 43 to discharge from the storage battery 42 toward the first coupling terminal 41. Thus, the load of the power supply units 21a to 21c for charging current Ia may be reduced. Further, by discharging toward the power supply line 14 (bus line), the load of the power supply units 21a to 21c may further be reduced. The fourth threshold value may be changed as appropriate. For example, the fourth threshold value may be changed based on the electricity storage amount (inter-terminal voltage V42, SOC) of the storage battery 42.

In each of the embodiments described above, the variation amount per unit time of the terminal voltage V41 may further be obtained. For example, a third threshold value is memorized in the memory 44a illustrated in FIG. 2. The controller 44 may control the power converter 43 to decrease the charging current Ia assuming the variation amount of the terminal voltage V41 is equal to or larger than the third threshold value. Further, the controller 44 may control the power converter 43 such that the charging current Ia becomes 0 (zero) assuming the variation amount is equal to or larger than the third threshold value. Still further, the controller 44 may control the power converter 43 to switch to discharging assuming the variation amount is equal to or larger than the third threshold value.

In each of the embodiments described above, in at least one of the three battery units 22a to 22c, the value of the first threshold value memorized in the memory 44a of the controller 44 may be different from the first threshold values set in other battery units. Assuming the first value and the second value are set as the first threshold value, the first value and the second value in one battery unit may be different from the first values and the second values in other battery units. Further, the first threshold values of the three battery units 22a to 22c may be set to values different from each other. Assuming the first value and the second value are set as the first threshold value, the first values and the second values of the three battery units 22a to 22c may be set to values different from each other. In the battery unit for which the first threshold value lower than the first threshold value of other battery units is set, decreasing the charging current Ia begins later than in other battery units. That is, by setting the low first threshold value, the charging may be maintained.

The first threshold value may be changed in accordance with the electricity storage amount (inter-terminal voltage V42, SOC) of the storage battery 42. For example, a value proportional to the electricity storage amount of the storage battery 42 is set as the first threshold value. In the case above, the power converter 43 is controlled such that the charging current Ia is decreased earlier in the battery unit for which a high first threshold value is set than in the battery unit for which a low first threshold value is set. Thus, the storage batteries 42 of all the battery units may efficiently be charged. As a result, the time required for fully charging the storage batteries 42 of all the battery units may be shortened.

Further, by setting different values to the first threshold values of the battery units 22a to 22c, the load of the power supply units 21a to 21c may be reduced in a stepwise manner. For example, the first threshold values are set to the battery units 22a, 22b, and 22c illustrated in FIG. 1 in the descending order. In the case above, as the terminal voltage V41 lowers, the charging current Ia is decreased in order from the battery unit 22a for which the highest first threshold value is set. Accordingly, as the terminal voltage V41 lowers, the number of battery units which decrease the charging current Ia increases. As described above, the battery units of the number depending on the magnitude of the load of the device 13 decrease the charging current Ia, and thus, the load may efficiently be reduced.

The battery units 22a to 22c and 22X described above may be coupled to a power supply unit other than the power supply units 21a to 21c illustrated in FIG. 1, that is, a power supply unit not having the droop characteristics, for example. Further, the battery units 22a to 22c and 22X may be coupled to the power supply units 21a to 21c having the droop characteristics and a power supply unit not having the droop characteristics.

The phrase “at least one” used in the present description means “one or more” of the desired alternatives. As an example, the phrase “at least one” used in the present description means “only one option” or “both of two options” assuming the number of options is two. As another example, the phrase “at least one” used in the present description means “only one option” or “combination of any two or more options” assuming the number of options is three or more.

### (Appendix)

The technical ideas that can be taken from the present disclosure will be described below.

### [A1]

A battery unit, including
a first coupling terminal,
a second coupling terminal configured to be coupled to a storage battery,
a power converter coupled between the first coupling terminal and the second coupling terminal, and
a controller configured to control the power converter and to measure a terminal voltage of the first coupling terminal and a current flowing from the power converter to the second coupling terminal,
in which, in a state that a current is flowing from the power converter to the second coupling terminal, the controller compares the terminal voltage and a first threshold value, and assuming the terminal voltage crosses the first threshold value, the controller controls the power converter to decrease the current flowing from the power converter to the second coupling terminal until the terminal voltage crosses the first threshold value again.

### [A2]

The battery unit according to [A1],
in which crossing the first threshold value of the terminal voltage corresponds to the terminal voltage falling below the first threshold value, and
crossing the first threshold value again of the terminal voltage corresponds to the terminal voltage exceeding the first threshold value.

### [A3]

The battery unit according to [A1] or [A2],
in which the first coupling terminal is coupled between a power supply unit having output characteristics in which an output voltage varies depending on an output current and a device coupled to an output terminal of the power supply unit, in parallel with the device relative to the power supply unit.

### [A4]

The battery unit according to [A3],
in which a plurality of the power supply units are coupled to the device in parallel, and
the output characteristics are droop characteristics in which the output voltage lowers as the output current increases.

### [A5]

The battery unit according to any one of [A1] to [A4],
in which in a state that a current is flowing from the power converter to the second coupling terminal, the controller compares a variation amount of the terminal voltage in a unit time and a third threshold value, and controls the power converter to decrease the current flowing from the power converter to the second coupling terminal, assuming the variation amount is equal to or larger than the third threshold value.

### [A6]

The battery unit according to any one of [A1] to [A4],
in which the power converter is configured to convert a voltage of the storage battery, and
in a state that a current is flowing from the power converter to the second coupling terminal, the controller compares a variation amount of the terminal voltage in a unit time and a third threshold value, and controls the power converter to make a current flow from the storage battery toward the first coupling terminal, assuming the variation amount is equal to or larger than the third threshold value.

### [A7]

The battery unit according to any one of [A1] to [A6],
in which the controller controls the power converter to gradually decrease a current flowing from the power converter to the second coupling terminal, assuming the terminal voltage crosses the first threshold value.

### [A8]

The battery unit according to any one of [A1] to [A7],
in which the controller controls the power converter to make a current flowing from the power converter to the second coupling terminal zero, assuming the terminal voltage crosses the first threshold value.

### [A9]

The battery unit according to any one of [A1] to [A8],
in which the controller controls the power converter to make a current flowing from the power converter to the second coupling terminal zero, assuming the terminal voltage crosses a second threshold value lower than the first threshold value.
   [A10] The battery unit according to [A9],
in which the controller invalidates comparison between the terminal voltage and the first threshold value and comparison between the terminal voltage and the second threshold value, assuming the terminal voltage crosses the second threshold value.

### [A11]

The battery unit according to any one of [A1] to [A10],
in which the controller controls the power converter to gradually increase a current flowing from the power converter to the second coupling terminal, assuming the terminal voltage crosses the first threshold value again.

### [A12]

The battery unit according to any one of [A1] to [A8],
in which the power converter is configured to convert a voltage of the storage battery, and
the controller controls the power converter to make a current flow from the storage battery toward the first coupling terminal, assuming the terminal voltage crosses a second threshold value lower than the first threshold value.

### [A13]

A battery unit including
a storage battery,
a first coupling terminal,
a second coupling terminal configured to be coupled to the storage battery,
a power converter coupled between the first coupling terminal and the second coupling terminal, and
a controller configured to control the power converter and to measure a terminal voltage of the first coupling terminal and a charging current flowing from the power converter to the second coupling terminal,
in which, in a state that the charging current is flowing, the controller compares the terminal voltage and a first threshold value, and assuming the terminal voltage crosses the first threshold value, the controller controls the power converter to decrease the charging current until the terminal voltage crosses the first threshold value again.

### [A14]

A power supply system including
a plurality of battery units coupled to a device in parallel,
in which each of the plurality of battery units includes
a storage battery,
a first coupling terminal configured to be coupled to the device,
a second coupling terminal configured to be coupled to the storage battery,
a power converter coupled between the first coupling terminal and the second coupling terminal, and
a controller configured to control the power converter and to measure a terminal voltage of the first coupling terminal and a charging current flowing from the power converter to the second coupling terminal,
the controller includes a memory configured to memorize a first threshold value, and
in a state that the charging current is flowing, the controller compares the terminal voltage and the first threshold value, and assuming the terminal voltage crosses the first threshold value, the controller controls the power converter to decrease the charging current until the terminal voltage crosses the first threshold value again.

### [A15]

The power supply system according to [A14],
in which the first threshold value of at least one battery unit in the plurality of battery units is set to a value different from the first threshold value of other battery units in the plurality of battery units.

### [A16]

The power supply system according to [A14],
in which the first threshold value of each of the plurality of battery units is set depending on an electricity storage amount of the storage battery.

### [A17]

The power supply system according to [A16],
in which the first threshold value of the battery unit in which the electricity storage amount is small is set to be lower than the first threshold value of the battery unit in which the electricity storage amount is large.

### [A18]

A power supply system including
a power supply unit including an output terminal configured to be coupled to a device, and configured to convert input power into DC power and to output the DC power to the output terminal and
a battery unit coupled to the device in parallel with the power supply unit,
in which the battery unit includes
a storage battery,
a first coupling terminal configured to be coupled to the output terminal,
a second coupling terminal configured to be coupled to the storage battery,
a power converter coupled between the first coupling terminal and the second coupling terminal, and
a controller configured to control the power converter and to measure a terminal voltage of the first coupling terminal and a charging current flowing from the power converter to the second coupling terminal,
in which, in a state that the charging current is flowing, the controller compares the terminal voltage and a first threshold value, and assuming the terminal voltage of the first coupling terminal crosses the first threshold value, the controller controls the power converter to decrease the charging current until the terminal voltage crosses the first threshold value again.

### [A19]

The power supply system according to [A18],
in which the first coupling terminal is coupled to the output terminal in parallel with the device, and
a plurality of the power supply units are coupled to the device in parallel, and have droop characteristics in which an output voltage lowers as an output current increases.

### [B1]

A battery unit, comprising:
a first coupling terminal;
a second coupling terminal configured to be coupled to a storage battery;
a power converter coupled between the first coupling terminal and the second coupling terminal; and
a controller configured to control the power converter, to measure a terminal voltage value of the first coupling terminal and a current flowing from the power converter to the second coupling terminal, and to compare the terminal voltage value and a first threshold value being set,
wherein the first threshold value includes a first value and a second value being set within a voltage range including the first threshold value, and
in a state that the current is flowing from the power converter to the second coupling terminal, assuming the terminal voltage value varies in a predetermined direction and crosses the first value, the controller controls the power converter to decrease the current flowing from the power converter to the second coupling terminal until the terminal voltage value varies in a direction opposite to the predetermined direction and crosses the second value.

### [B2]

The battery unit according to [B1],
wherein varying in the predetermined direction and crossing the first value of the terminal voltage value mean that the terminal voltage value falls below the first value, and
varying in the direction opposite to the predetermined direction and crossing the second value of the terminal voltage value mean that the terminal voltage value exceeds the second value.

### [B3]

The battery unit according to [B1] or [B2],
wherein the first coupling terminal is coupled between a power supply unit having output characteristics in which an output voltage varies depending on an output current and a device coupled to an output terminal of the power supply unit, in parallel with the device relative to the power supply unit.

### [B4]

The battery unit according to [B3],
wherein a plurality of the power supply units are coupled to the device in parallel, and
the output characteristics are droop characteristics in which the output voltage lowers as the output current increases.

### [B5]

The battery unit according to any one of [B1] to [B4],
wherein in a state that a current is flowing from the power converter to the second coupling terminal, the controller compares a variation amount of the terminal voltage value in a unit time and a third threshold value being set, and controls the power converter to decrease the current flowing from the power converter to the second coupling terminal, assuming the variation amount is equal to or larger than the third threshold value.

### [B6]

The battery unit according to any one of [B1] to [B4],
wherein the power converter is configured to convert a voltage of the storage battery, and
in a state that a current is flowing from the power converter to the second coupling terminal, the controller compares a variation amount of the terminal voltage value in a unit time and a third threshold value being set, and controls the power converter to make a current flow from the storage battery toward the first coupling terminal, assuming the variation amount is equal to or larger than the third threshold value.

### [B7]

The battery unit according to any one of [B1] to [B6],
wherein the controller controls the power converter to gradually decrease a current flowing from the power converter to the second coupling terminal, assuming the terminal voltage value varies in the predetermined direction and crosses the first value.

### [B8]

The battery unit according to any one of [B1] to [B7],
wherein the controller controls the power converter to make a current flowing from the power converter to the second coupling terminal zero, assuming the terminal voltage value varies in the predetermined direction and crosses the first value.

### [B9]

The battery unit according to any one of [B1] to [B8],
wherein the controller controls the power converter to make a current flowing from the power converter to the second coupling terminal zero, assuming the terminal voltage value varies in the predetermined direction and crosses a second threshold value lower than the first threshold value.

### [B10]

The battery unit according to [B9],
wherein the controller invalidates comparison between the terminal voltage value and the first threshold value and comparison between the terminal voltage and the second threshold value, assuming the terminal voltage value crosses the second threshold value.

### [B11]

The battery unit according to any one of [B1] to [B10],
wherein the controller controls the power converter to gradually increase a current flowing from the power converter to the second coupling terminal, assuming the terminal voltage value crosses the second value in the direction opposite to the predetermined direction.

### [B12]

The battery unit according to any one of [B1] to [B8],
wherein the power converter is configured to convert a voltage of the storage battery, and
the controller controls the power converter to make a current flow from the storage battery toward the first coupling terminal, assuming the terminal voltage value varies in the predetermined direction and crosses a second threshold value lower than the first threshold value.

### [B13]

A battery unit, comprising:
a storage battery;
a first coupling terminal;
a second coupling terminal configured to be coupled to the storage battery;
a power converter coupled between the first coupling terminal and the second coupling terminal; and
a controller configured to control the power converter, to measure a terminal voltage value of the first coupling terminal and a charging current flowing from the power converter to the second coupling terminal, and to compare the terminal voltage value and a first threshold value being set,
wherein the first threshold value includes a first value and a second value within a voltage range including the first threshold value, and
in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

### [B14]

A power supply system, comprising:
a plurality of battery units coupled to a device in parallel,
wherein each of the plurality of battery units includes
a storage battery,
a first coupling terminal configured to be coupled to the device,
a second coupling terminal configured to be coupled to the storage battery,
a power converter coupled between the first coupling terminal and the second coupling terminal, and
a controller configured to control the power converter, to measure a terminal voltage value of the first coupling terminal and a charging current flowing from the power converter to the second coupling terminal, and to compare the terminal voltage value and a first threshold value being set,
the controller includes a memory configured to memorize the first threshold value,
the first threshold value includes a first value and a second value within a voltage range including the first threshold value, and
in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

### [B15]

The power supply system according to [B14],
wherein the first value and the second value of at least one battery unit in the plurality of battery units are set to values different from the first values and the second values of other battery units in the plurality of battery units.

### [B16]

The power supply system according to [B14],
wherein the first value and the second value of each of the plurality of battery units are set depending on an electricity storage amount of the storage battery.

### [B17]

The power supply system according to [B16],
wherein the first value and the second value of the battery unit in which the electricity storage amount is small are set to be lower than the first value and the second value of the battery unit in which the electricity storage amount is large.

### [B18]

A power supply system, comprising:
a power supply unit including an output terminal configured to be coupled to a device, and configured to convert input power into DC power and to output the DC power to the output terminal; and
a battery unit coupled to the device in parallel with the power supply unit,
wherein the battery unit includes
a storage battery,
a first coupling terminal configured to be coupled to the output terminal,
a second coupling terminal configured to be coupled to the storage battery,
a power converter coupled between the first coupling terminal and the second coupling terminal, and
a controller configured to control the power converter, to measure a terminal voltage value of the first coupling terminal and a charging current flowing from the power converter to the second coupling terminal, and to compare the terminal voltage value and a first threshold value being set,
the first threshold value includes a first value and a second value within a voltage range including the first threshold value, and
in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

### [B19]

The power supply system according to [B18],
wherein the first coupling terminal is coupled to the output terminal in parallel with the device, and
a plurality of the power supply units are coupled to the device in parallel, and have droop characteristics in which an output voltage lowers as an output current increases.

### [B20]

The battery unit according to any one of [B1] to [B13],
wherein the first value and the second value are the same.

### [B21]

The power supply system according to any one of [B14] to [B19], in which the first value and the second value are the same.

The foregoing description is merely exemplary. Those skilled in the art may recognize that many more conceivable combinations and substitutions are possible other than the constituents and methods (manufacturing processes) listed for the purpose of describing the technology of the present disclosure. The present disclosure is intended to embrace all alternatives, modifications and variances that fall within the scope of the present disclosure including the appended claims.

### REFERENCE SIGNS LIST

11 POWER SUPPLY SYSTEM
12 AC POWER SUPPLY
13 DEVICE
14 POWER SUPPLY LINE
21a to 21c POWER SUPPLY UNIT
22a to 22c, 22X BATTERY UNIT
31 INPUT TERMINAL
32 OUTPUT TERMINAL
33 AC-DC CONVERTER
34 DC-DC CONVERTER
35 CONTROLLER
41, 41a, 41b FIRST COUPLING TERMINAL
42 STORAGE BATTERY
43 POWER CONVERTER
44 CONTROLLER
44a MEMORY
44b COMMUNICATOR
44c TIMER
45, 46 VOLTAGE DETECTOR
47 CURRENT DETECTOR
48, 48X SECOND COUPLING TERMINAL
51 to 55 STEP
80 SETTING TERMINAL
91 TEST LOAD
Ia CHARGING CURRENT
Ib DISCHARGING CURRENT
L11 INDUCTOR
P21 OPERATIONAL AMPLIFIER
Q11, Q12 SWITCHING ELEMENT
R11, R12, R21, R31, R32 RESISTOR
T10 to T16 TIME
T20 to T24 TIME
V41 TERMINAL VOLTAGE
V42 INTER-TERMINAL VOLTAGE

1. A battery unit, comprising:
a first coupling terminal;
a second coupling terminal configured to be coupled to a storage battery;
a power converter coupled between the first coupling terminal and the second coupling terminal; and
a controller configured to control the power converter, to measure a terminal voltage value of the first coupling terminal and a current flowing from the power converter to the second coupling terminal, and to compare the terminal voltage value and a first threshold value being set,
wherein the first threshold value includes a first value and a second value being set within a voltage range including the first threshold value, and
in a state that the current is flowing from the power converter to the second coupling terminal, assuming the terminal voltage value varies in a predetermined direction and crosses the first value, the controller controls the power converter to decrease the current flowing from the power converter to the second coupling terminal until the terminal voltage value varies in a direction opposite to the predetermined direction and crosses the second value.

2. The battery unit according to claim 1,
wherein varying in the predetermined direction and crossing the first value of the terminal voltage value mean that the terminal voltage value falls below the first value, and
varying in the direction opposite to the predetermined direction and crossing the second value of the terminal voltage value mean that the terminal voltage value exceeds the second value.

3. The battery unit according to claim 2,
wherein the first coupling terminal is coupled between a power supply unit having output characteristics in which an output voltage varies depending on an output current and a device coupled to an output terminal of the power supply unit, in parallel with the device relative to the power supply unit.

4. The battery unit according to claim 3,
wherein a plurality of the power supply units are coupled to the device in parallel, and
the output characteristics are droop characteristics in which the output voltage lowers as the output current increases.

5. The battery unit according to claim 4,
wherein in a state that a current is flowing from the power converter to the second coupling terminal, the controller compares a variation amount of the terminal voltage value in a unit time and a third threshold value being set, and controls the power converter to decrease the current flowing from the power converter to the second coupling terminal, assuming the variation amount is equal to or larger than the third threshold value.

6. The battery unit according to claim 4,
wherein the power converter is configured to convert a voltage of the storage battery, and
in a state that a current is flowing from the power converter to the second coupling terminal, the controller compares a variation amount of the terminal voltage value in a unit time and a third threshold value being set, and controls the power converter to make a current flow from the storage battery toward the first coupling terminal, assuming the variation amount is equal to or larger than the third threshold value.

7. The battery unit according to claim 6,
wherein the controller controls the power converter to gradually decrease a current flowing from the power converter to the second coupling terminal, assuming the terminal voltage value varies in the predetermined direction and crosses the first value.

8. The battery unit according to claim 7,
wherein the controller controls the power converter to make a current flowing from the power converter to the second coupling terminal zero, assuming the terminal voltage value varies in the predetermined direction and crosses the first value.

9. The battery unit according to claim 8,
wherein the controller controls the power converter to make a current flowing from the power converter to the second coupling terminal zero, assuming the terminal voltage value varies in the predetermined direction and crosses a second threshold value lower than the first threshold value.

10. The battery unit according to claim 9,
wherein the controller invalidates comparison between the terminal voltage value and the first threshold value and comparison between the terminal voltage value and the second threshold value, assuming the terminal voltage value crosses the second threshold value.

11. The battery unit according to claim 10,
wherein the controller controls the power converter to gradually increase a current flowing from the power converter to the second coupling terminal, assuming the terminal voltage value crosses the second value in the direction opposite to the predetermined direction.

12. The battery unit according to claim 8,
wherein the power converter is configured to convert a voltage of the storage battery, and
the controller controls the power converter to make a current flow from the storage battery toward the first coupling terminal, assuming the terminal voltage value varies in the predetermined direction and crosses a second threshold value lower than the first threshold value.

13. A battery unit, comprising:
a storage battery;
a first coupling terminal;
a second coupling terminal configured to be coupled to the storage battery;
a power converter coupled between the first coupling terminal and the second coupling terminal; and
a controller configured to control the power converter, to measure a terminal voltage value of the first coupling terminal and a charging current flowing from the power converter to the second coupling terminal, and to compare the terminal voltage value and a first threshold value being set,
wherein the first threshold value includes a first value and a second value within a voltage range including the first threshold value, and
in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

14. A power supply system, comprising:
a plurality of battery units coupled to a device in parallel,
wherein each of the plurality of battery units includes
a storage battery,
a first coupling terminal configured to be coupled to the device,
a second coupling terminal configured to be coupled to the storage battery,
a power converter coupled between the first coupling terminal and the second coupling terminal, and
a controller configured to control the power converter, to measure a terminal voltage value of the first coupling terminal and a charging current flowing from the power converter to the second coupling terminal, and to compare the terminal voltage value and a first threshold value being set,
the controller includes a memory configured to memorize the first threshold value,
the first threshold value includes a first value and a second value within a voltage range including the first threshold value, and
in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

15. The power supply system according to claim 14,
wherein the first value and the second value of at least one battery unit in the plurality of battery units are set to values different from the first values and the second values of other battery units in the plurality of battery units.

16. The power supply system according to claim 14,
wherein the first value and the second value of each of the plurality of battery units are set depending on an electricity storage amount of the storage battery.

17. The power supply system according to claim 16,
wherein the first value and the second value of the battery unit in which the electricity storage amount is small are set to be lower than the first value and the second value of the battery unit in which the electricity storage amount is large.

18. A power supply system, comprising:
a power supply unit including an output terminal configured to be coupled to a device, and configured to convert input power into DC power and to output the DC power to the output terminal; and
a battery unit coupled to the device in parallel with the power supply unit,
wherein the battery unit includes
a storage battery,
a first coupling terminal configured to be coupled to the output terminal,
a second coupling terminal configured to be coupled to the storage battery,
a power converter coupled between the first coupling terminal and the second coupling terminal, and
a controller configured to control the power converter, to measure a terminal voltage value of the first coupling terminal and a charging current flowing from the power converter to the second coupling terminal, and to compare the terminal voltage value and a first threshold value being
the first threshold value includes a first value and a second value within a voltage range including the first threshold value, and
in a state that the charging current is flowing, assuming the terminal voltage value varies in a predetermined direction and crosses the first value, the controller controls the power converter to decrease the charging current until the terminal voltage value varies in a direction opposite to the predetermined direction and crosses the second value.

19. The power supply system according to claim 18,
wherein the first coupling terminal is coupled to the output terminal in parallel with the device, and
a plurality of the power supply units are coupled to the device in parallel, and have droop characteristics in which an output voltage lowers as an output current increases.

20. The battery unit according to claim 13,
wherein the first value and the second value are the same.
